(19) United States
(12) Patent Application Publication
(10) Pub. No.: US 2025/0147846 A1
(43) Pub. Date: May 8, 2025

(54) SORTING RETIRED BLOCKS OF NON-VOLATILE MEMORY CELLS

(71) Applicant: Micron Technology, Inc., Boise, ID (US)

(72) Inventors: Marco Redaelli, Munich (DE); Gaurav Sinha, Oberschleißheim (DE); Zhang Lei, Singapore (SG)

(21) Appl. No.: 18/776,211

(22) Filed: Jul. 17, 2024

Related U.S. Application Data
(60) Provisional application No. 63/595,691, filed on Nov. 2, 2023.

(51) Int. Cl. G06F 11/10; G06F 11/07

(52) U.S. Cl. CPC G06F 11/108; G06F 11/076; G06F 11/1016

(57) ABSTRACT

Methods, systems, and devices for sorting retired blocks of non-volatile memory cells are described. A memory system may recover a block that has been marked as “bad” using a requalification process. For example, after operating in an error protection mode for the block, the memory system may monitor the block to determine whether a status flag indicating an access error is set. If the status flag is set, the memory system may store information that indicates the block is unrecoverable, and the block may subsequently be retired. Alternatively, if a status flag is not set, the memory system may store information that indicates the block may be recoverable. If one or more additional access operations to the block are successful, the memory system may store information that indicates the block may be used for subsequent access operations.

### CROSS REFERENCE

The present Application for Patent claims priority to and the benefit of U.S. Patent Application No. 63/595,691 by Redaelli et al., entitled “SORTING RETIRED BLOCKS OF NON-VOLATILE MEMORY CELLS,” filed Nov. 2, 2023, assigned to the assignee hereof, and is expressly incorporated by reference in its entirety herein.

### TECHNICAL FIELD

The following relates to one or more systems for memory, including sorting retired blocks of non-volatile memory cells.

### BACKGROUND

Memory devices are widely used to store information in devices such as computers, user devices, wireless communication devices, cameras, digital displays, and others, including devices having higher reliability uses, such as automotive applications. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports sorting retired blocks of non-volatile memory cells in accordance with examples as disclosed herein.

FIG. 2 shows an example of a system that supports sorting retired blocks of non-volatile memory cells in accordance with examples as disclosed herein.

FIG. 3 shows an example of a process flow that supports sorting retired blocks of non-volatile memory cells in accordance with examples as disclosed herein.

FIGS. 4A and 4B show examples of sets of metadata that support sorting retired blocks of non-volatile memory cells in accordance with examples as disclosed herein.

FIG. 5 shows a block diagram of a memory system that supports sorting retired blocks of non-volatile memory cells in accordance with examples as disclosed herein.

FIG. 6 shows a flowchart illustrating a method or methods that support sorting retired blocks of non-volatile memory cells in accordance with examples as disclosed herein.

### DETAILED DESCRIPTION

A memory system may execute an error correction mode for a valid block of memory cells within one or more memory arrays of the memory system to recover corrupted data within the valid block. For example, if the memory system detects an error in data stored to a valid block (e.g., as part of a read operation), the memory system may perform one or more error correction operations to attempt to correct the error. If the error correction operations are unsuccessful, a host system may trigger the error correction mode, which may be associated with increased correction and protection of the data by adjusting a ratio of data bits to parity bits and storing data in various locations within the memory system. In some cases, a memory system may retire a valid block having invalid bits (e.g., may mark the block as unusable or “bad”) after executing the error correction mode for the valid block, such as by placing the block in a retired block pool.

The error protection mode may be triggered by identifying one or more errors within the valid block. Such errors may be caused by extrinsic defects associated with the valid block, such as excessive wear or manufacturing defects, or may be caused by intrinsic operating conditions, such as errors caused by long-term data retention, read disturbs due to extended stress, cross temperatures, or some combination of both. In some cases, a valid block which includes errors caused by intrinsic operating conditions may be recoverable (e.g., may still be used, after a requalification process, to reliably store data). Accordingly, retiring such valid blocks may prematurely remove the valid block from use. In some examples, if the spare block pool of a memory system is empty, the memory system may revert to a “write protect” state in which the memory system may not execute write operations. The write protect state may include interventions such as replacing the memory system or components of the memory system (e.g., in an automobile environment or personal computing environment), or may cause a device which uses the memory system to become inoperable, among other aspects.

As described herein, a memory system may recover a valid block that has been marked as “bad” using a requalification process. For example, after operating in an error protection mode for the valid block, the memory system may monitor the valid block to determine whether a status flag indicating an access error (e.g., a program status failure, an erase status failure) is set. If the status flag is set, the memory system may store information that indicates the valid block is unrecoverable, and the valid block may subsequently be retired (e.g., remain unused for subsequent access operations). Alternatively, if the status flag is not set, the memory system may store information that indicates the valid block may be recoverable. While in an idle mode, the memory system may perform a requalification process on the valid block, such as by performing one or more additional access operations. If the one or more additional access operations are successful, the memory system may store information that indicates the valid memory block may be used for subsequent access operations (e.g., may add the valid block to a spare block pool). Such methods to requalify a valid block may improve memory system reliability and increase the useful life of the memory system, reduce manufacturing costs (e.g., by allowing for increased yield), and allow for more robust manufacturing processes (e.g., improved soldering processes), among other benefits.

In addition to applicability in memory systems as described herein, techniques for sorting retired blocks of non-volatile memory cells may be generally implemented to support virtual reality or augmented reality applications. As the presence and use of virtual, augmented, extended, and/or other reality devices increases, electronic devices that support unique aspects of these technologies may be desired. For example, virtual reality and augmented reality devices and applications may benefit from faster processing to boost user immersion, and wearable electronic devices that support virtual reality or augmented reality may be subject to various size, weight, or other constraints. Implementing the techniques described herein may support virtual, augmented, extended, and/or other reality devices or techniques by increasing reliability and lifetime of a memory system, which may allow for reduced device size and may thus result in smaller wearable devices, among other benefits.

In addition to applicability in memory systems as described herein, techniques for sorting retired blocks of non-volatile memory cells may be generally implemented to support increased connectivity of electronic systems. As the use of systems relying on interconnected electronic devices increases, the connectivity of these electronic devices becomes an increasingly relevant factor for the operations of the system. For example, delays associated with signals communicated between devices may become increasingly relevant as critical systems come to rely more on connectivity, as a system uses larger quantities of interconnected devices, or if the quantity and the complexity of signals communicated between devices increases. Implementing the techniques described herein may support techniques for increased connectivity in electronic systems by increasing reliability of electronic devices, which may support improved data transfer techniques between devices, among other benefits.

In addition to applicability in memory systems as described herein, techniques for sorting retired blocks of non-volatile memory cells may be generally implemented to support cloud computing and storage applications. As the use of cloud computing to provide processing, storage, and networking services to multiple devices increases, many devices and systems may benefit from improved remote processing and storage capabilities. For example, increasing reliability or other capabilities may result in larger and more accessible storage options for users, and increasing memory access times may result in faster processing for computing or database applications. Implementing the techniques described herein may support cloud computing and storage techniques by improving storage capacities of cloud servers, resulting in increased response times and decreased processing times, among other benefits.

In addition to applicability in memory systems as described herein, techniques for sorting retired blocks of non-volatile memory cells may be generally implemented to support edge computing applications. Edge computing is a distributed computing paradigm that brings computation and data storage closer to the sources of data than traditional cloud services. As the use of edge computing to provide computing, storage, and networking services at locations that are geographically closer to end users increases, many devices and systems may benefit from improved processing, performance, and storage at edge devices. For example, increasing memory density, reliability, and processing power of edge devices may decrease a reliance on the devices to remote computing or devices, which may otherwise increase latency of operations performed at the devices. Implementing the techniques described herein may support edge computing techniques by increasing reliability associated with edge computing devices, which may improve response times and other functions associated with edge computing devices, among other benefits.

Features of the disclosure are illustrated and described in the context of systems, devices, and circuits. Features of the disclosure are further illustrated and described in the context of process flows, metadata tables, and a flowchart.

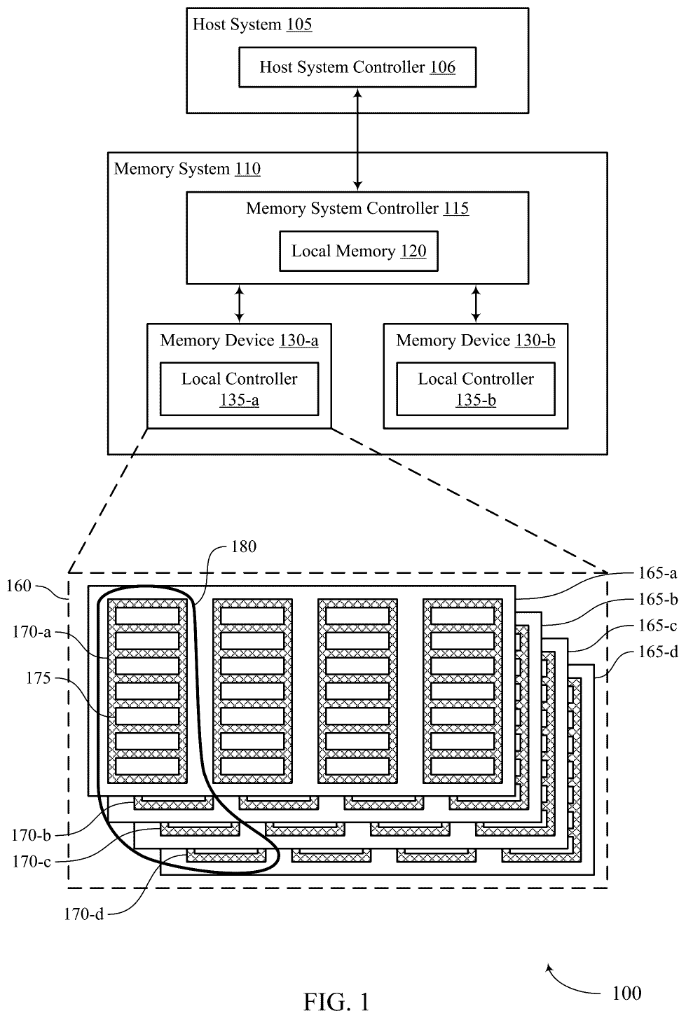

FIG. 1 shows an example of a system 100 that supports sorting retired blocks of non-volatile memory cells in accordance with examples as disclosed herein. The system 100 includes a host system 105 coupled with a memory system 110. The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that supports sorting retired blocks of non-volatile memory cells. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

In some cases, a memory system 110 may recover a block 170 that has been marked as “bad” using a requalification process. For example, after operating in an error protection mode for the block 170, the memory system 110 may monitor the block 170 to determine whether a status flag indicating an access error (e.g., a program status failure, an erase status failure) is set. If the status flag is set, the memory system 110 may store information that indicates the block 170 is unrecoverable, and the block 170 may subsequently be retired (e.g., remain unused for subsequent access operations). Alternatively, if a status flag is not set, the memory system may store information that indicates the block 170 may be recoverable. While in an idle mode, the memory system 110 may perform a requalification process on the block 170, such as by performing one or more additional access operations. If the one or more additional access operations are successful, the memory system 110 may store information that indicates the block 170 may be used for subsequent access operations. The memory system 110 may thereby reduce a quantity of blocks 170 that are retired by performing the requalification process described herein. Such methods to requalify a block 170 may improve memory system reliability and increase the useful life of the memory system, among other benefits.

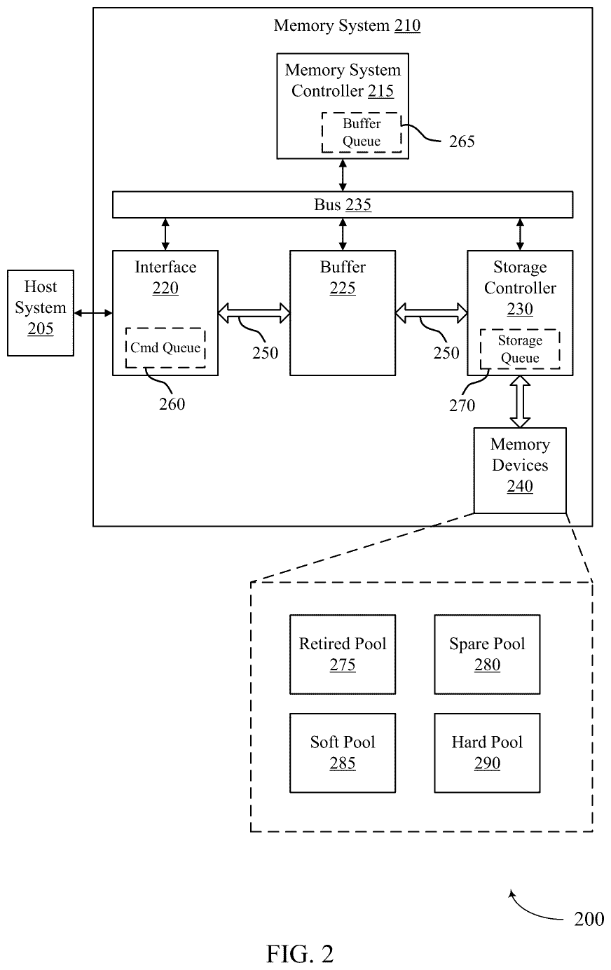

FIG. 2 shows an example of a system 200 that supports sorting retired blocks of non-volatile memory cells in accordance with examples as disclosed herein. The system 200 may be an example of a system 100 as described with reference to FIG. 1, or aspects thereof. The system 200 may include a memory system 210 configured to store data received from the host system 205 and to send data to the host system 205, if requested by the host system 205 using access commands (e.g., read commands or write commands). The system 200 may implement aspects of the system 100 as described with reference to FIG. 1. For example, the memory system 210 and the host system 205 may be examples of the memory system 110 and the host system 105, respectively.

The memory system 210 may include one or more memory devices 240 to store data transferred between the memory system 210 and the host system 205 (e.g., in response to receiving access commands from the host system 205). The memory devices 240 may include one or more memory devices as described with reference to FIG. 1. For example, the memory devices 240 may include NAND memory, PCM, self-selecting memory, 3D cross point or other chalcogenide-based memories, FERAM, MRAM, NOR (e.g., NOR flash) memory, STT-MRAM, CBRAM, RRAM, or OxRAM, among other examples.

The memory system 210 may include a storage controller 230 for controlling the passing of data directly to and from the memory devices 240 (e.g., for storing data, for retrieving data, for determining memory locations in which to store data and from which to retrieve data). The storage controller 230 may communicate with memory devices 240 directly or via a bus (not shown), which may include using a protocol specific to each type of memory device 240. In some cases, a single storage controller 230 may be used to control multiple memory devices 240 of the same or different types. In some cases, the memory system 210 may include multiple storage controllers 230 (e.g., a different storage controller 230 for each type of memory device 240). In some cases, a storage controller 230 may implement aspects of a local controller 135 as described with reference to FIG. 1.

The memory system 210 may include an interface 220 for communication with the host system 205, and a buffer 225 for temporary storage of data being transferred between the host system 205 and the memory devices 240. The interface 220, buffer 225, and storage controller 230 may support translating data between the host system 205 and the memory devices 240 (e.g., as shown by a data path 250), and may be collectively referred to as data path components.

Using the buffer 225 to temporarily store data during transfers may allow data to be buffered while commands are being processed, which may reduce latency between commands and may support arbitrary data sizes associated with commands. This may also allow bursts of commands to be handled, and the buffered data may be stored, or transmitted, or both (e.g., after a burst has stopped). The buffer 225 may include relatively fast memory (e.g., some types of volatile memory, such as SRAM or DRAM), or hardware accelerators, or both to allow fast storage and retrieval of data to and from the buffer 225. The buffer 225 may include data path switching components for bi-directional data transfer between the buffer 225 and other components.

A temporary storage of data within a buffer 225 may refer to the storage of data in the buffer 225 during the execution of access commands. For example, after completion of an access command, the associated data may no longer be maintained in the buffer 225 (e.g., may be overwritten with data for additional access commands). In some examples, the buffer 225 may be a non-cache buffer. For example, data may not be read directly from the buffer 225 by the host system 205. In some examples, read commands may be added to a queue without an operation to match the address to addresses already in the buffer 225 (e.g., without a cache address match or lookup operation).

The memory system 210 also may include a memory system controller 215 for executing the commands received from the host system 205, which may include controlling the data path components for the moving of the data. The memory system controller 215 may be an example of the memory system controller 115 as described with reference to FIG. 1. A bus 235 may be used to communicate between the system components.

In some cases, one or more queues (e.g., a command queue 260, a buffer queue 265, a storage queue 270) may be used to control the processing of access commands and the movement of corresponding data. This may be beneficial, for example, if more than one access command from the host system 205 is processed concurrently by the memory system 210. The command queue 260, buffer queue 265, and storage queue 270 are depicted at the interface 220, memory system controller 215, and storage controller 230, respectively, as examples of a possible implementation. However, queues, if implemented, may be positioned anywhere within the memory system 210.

Data transferred between the host system 205 and the memory devices 240 may be conveyed along a different path in the memory system 210 than non-data information (e.g., commands, status information). For example, the system components in the memory system 210 may communicate with each other using a bus 235, while the data may use the data path 250 through the data path components instead of the bus 235. The memory system controller 215 may control how and if data is transferred between the host system 205 and the memory devices 240 by communicating with the data path components over the bus 235 (e.g., using a protocol specific to the memory system 210).

If a host system 205 transmits access commands to the memory system 210, the commands may be received by the interface 220 (e.g., according to a protocol, such as a UFS protocol or an eMMC protocol). Thus, the interface 220 may be considered a front end of the memory system 210. After receipt of each access command, the interface 220 may communicate the command to the memory system controller 215 (e.g., via the bus 235). In some cases, each command may be added to a command queue 260 by the interface 220 to communicate the command to the memory system controller 215.

The memory system controller 215 may determine that an access command has been received based on the communication from the interface 220. In some cases, the memory system controller 215 may determine the access command has been received by retrieving the command from the command queue 260. The command may be removed from the command queue 260 after it has been retrieved (e.g., by the memory system controller 215). In some cases, the memory system controller 215 may cause the interface 220 (e.g., via the bus 235) to remove the command from the command queue 260.

After a determination that an access command has been received, the memory system controller 215 may execute the access command. For a read command, this may include obtaining data from one or more memory devices 240 and transmitting the data to the host system 205. For a write command, this may include receiving data from the host system 205 and moving the data to one or more memory devices 240. In either case, the memory system controller 215 may use the buffer 225 for, among other things, temporary storage of the data being received from or sent to the host system 205. The buffer 225 may be considered a middle end of the memory system 210. In some cases, buffer address management (e.g., pointers to address locations in the buffer 225) may be performed by hardware (e.g., dedicated circuits) in the interface 220, buffer 225, or storage controller 230.

To process a write command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the write command.

In some cases, a buffer queue 265 may be used to control a flow of commands associated with data stored in the buffer 225, including write commands. The buffer queue 265 may include the access commands associated with data currently stored in the buffer 225. In some cases, the commands in the command queue 260 may be moved to the buffer queue 265 by the memory system controller 215 and may remain in the buffer queue 265 while the associated data is stored in the buffer 225. In some cases, each command in the buffer queue 265 may be associated with an address at the buffer 225. For example, pointers may be maintained that indicate where in the buffer 225 the data associated with each command is stored. Using the buffer queue 265, multiple access commands may be received sequentially from the host system 205 and at least portions of the access commands may be processed concurrently.

If the buffer 225 has sufficient space to store the write data, the memory system controller 215 may cause the interface 220 to transmit an indication of availability to the host system 205 (e.g., a “ready to transfer” indication), which may be performed in accordance with a protocol (e.g., a UFS protocol, an eMMC protocol). As the interface 220 receives the data associated with the write command from the host system 205, the interface 220 may transfer the data to the buffer 225 for temporary storage using the data path 250. In some cases, the interface 220 may obtain (e.g., from the buffer 225, from the buffer queue 265) the location within the buffer 225 to store the data. The interface 220 may indicate to the memory system controller 215 (e.g., via the bus 235) if the data transfer to the buffer 225 has been completed.

After the write data has been stored in the buffer 225 by the interface 220, the data may be transferred out of the buffer 225 and stored in a memory device 240, which may involve operations of the storage controller 230. For example, the memory system controller 215 may cause the storage controller 230 to retrieve the data from the buffer 225 using the data path 250 and transfer the data to a memory device 240. The storage controller 230 may be considered a back end of the memory system 210. The storage controller 230 may indicate to the memory system controller 215 (e.g., via the bus 235) that the data transfer to one or more memory devices 240 has been completed.

In some cases, a storage queue 270 may support a transfer of write data. For example, the memory system controller 215 may push (e.g., via the bus 235) write commands from the buffer queue 265 to the storage queue 270 for processing. The storage queue 270 may include entries for each access command. In some examples, the storage queue 270 may additionally include a buffer pointer (e.g., an address) that may indicate where in the buffer 225 the data associated with the command is stored and a storage pointer (e.g., an address) that may indicate the location in the memory devices 240 associated with the data. In some cases, the storage controller 230 may obtain (e.g., from the buffer 225, from the buffer queue 265, from the storage queue 270) the location within the buffer 225 from which to obtain the data. The storage controller 230 may manage the locations within the memory devices 240 to store the data (e.g., performing wear-leveling, performing garbage collection). The entries may be added to the storage queue 270 (e.g., by the memory system controller 215). The entries may be removed from the storage queue 270 (e.g., by the storage controller 230, by the memory system controller 215) after completion of the transfer of the data.

To process a read command received from the host system 205, the memory system controller 215 may determine if the buffer 225 has sufficient available space to store the data associated with the command. For example, the memory system controller 215 may determine (e.g., via firmware, via controller firmware), an amount of space within the buffer 225 that may be available to store data associated with the read command.

In some cases, the buffer queue 265 may support buffer storage of data associated with read commands in a similar manner as discussed with respect to write commands. For example, if the buffer 225 has sufficient space to store the read data, the memory system controller 215 may cause the storage controller 230 to retrieve the data associated with the read command from a memory device 240 and store the data in the buffer 225 for temporary storage using the data path 250. The storage controller 230 may indicate to the memory system controller 215 (e.g., via the bus 235) when the data transfer to the buffer 225 has been completed.

In some cases, the storage queue 270 may be used to aid with the transfer of read data. For example, the memory system controller 215 may push the read command to the storage queue 270 for processing. In some cases, the storage controller 230 may obtain (e.g., from the buffer 225, from the storage queue 270) the location within one or more memory devices 240 from which to retrieve the data. In some cases, the storage controller 230 may obtain (e.g., from the buffer queue 265) the location within the buffer 225 to store the data. In some cases, the storage controller 230 may obtain (e.g., from the storage queue 270) the location within the buffer 225 to store the data. In some cases, the memory system controller 215 may move the command processed by the storage queue 270 back to the command queue 260.

After the data has been stored in the buffer 225 by the storage controller 230, the data may be transferred from the buffer 225 and sent to the host system 205. For example, the memory system controller 215 may cause the interface 220 to retrieve the data from the buffer 225 using the data path 250 and transmit the data to the host system 205 (e.g., according to a protocol, such as a UFS protocol or an eMMC protocol). For example, the interface 220 may process the command from the command queue 260 and may indicate to the memory system controller 215 (e.g., via the bus 235) that the data transmission to the host system 205 has been completed.

The memory system controller 215 may execute received commands according to an order (e.g., a first-in-first-out order, according to the order of the command queue 260). For each command, the memory system controller 215 may cause data corresponding to the command to be moved into and out of the buffer 225, as discussed herein. As the data is moved into and stored within the buffer 225, the command may remain in the buffer queue 265. A command may be removed from the buffer queue 265 (e.g., by the memory system controller 215) if the processing of the command has been completed (e.g., if data corresponding to the access command has been transferred out of the buffer 225). If a command is removed from the buffer queue 265, the address previously storing the data associated with that command may be available to store data associated with a new command.

In some examples, the memory system controller 215 may be configured for operations associated with one or more memory devices 240. For example, the memory system controller 215 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 205 and physical addresses (e.g., physical block addresses) associated with memory cells within the memory devices 240. For example, the host system 205 may issue commands indicating one or more LBAs and the memory system controller 215 may identify one or more physical block addresses indicated by the LBAs. In some cases, one or more contiguous LBAs may correspond to noncontiguous physical block addresses. In some cases, the storage controller 230 may be configured to perform one or more of the described operations in conjunction with or instead of the memory system controller 215. In some cases, the memory system controller 215 may perform the functions of the storage controller 230 and the storage controller 230 may be omitted.

The memory system 210 may implement one or more categories or “pools” for each of the blocks 170 within a memory device 240. For example, the memory system 210 may maintain a retired block pool 275 that includes one or more unreliable blocks 170 that are not used by the memory system 210 for access operations (e.g., bad blocks) and a spare block pool 280 that includes one or more valid blocks 170 that are available for access operations (e.g., program operations, subsequent read operations, subsequent erase operations). Additionally, or alternatively, the memory system 210 may maintain one or more pools associated with blocks that may have become defective (e.g., one or more grown bad block (GBB) pools), such as a hard pool 290 corresponding to blocks 170 that the memory system 210 may be subsequently retire (e.g., place in the retired block pool 275), and a soft pool 285 corresponding to blocks 170 that are eligible for a requalification flow.

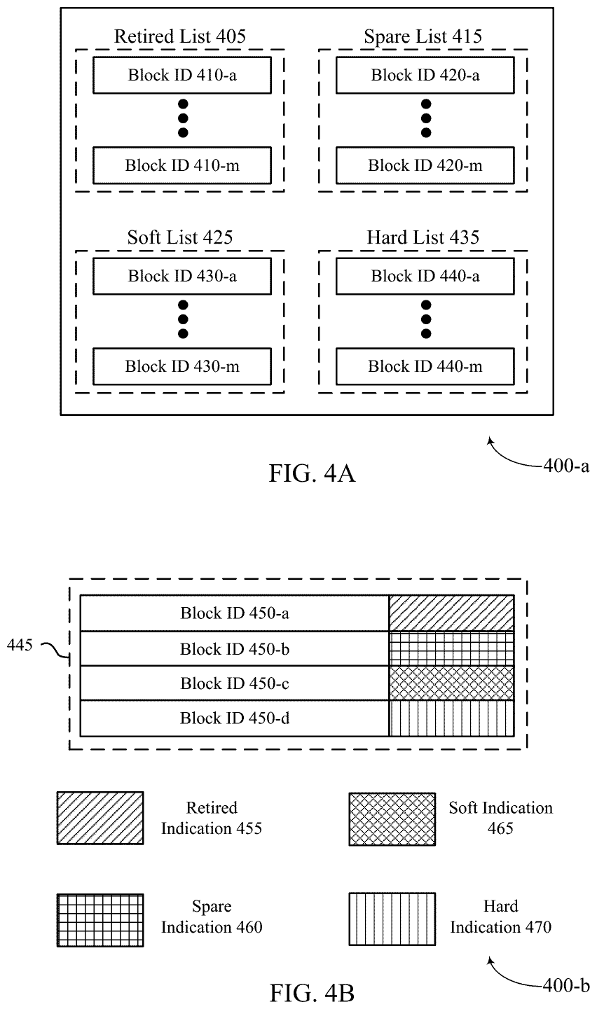

In some cases, the memory system may maintain (e.g., keep track of, store) the one or more categories or pools of blocks 170 using metadata associated with the blocks 170. For example, the memory system 210 may store metadata within each block indicating whether the block is in the retired block pool 275, the spare block pool 280, the soft pool 285, or the hard pool 290. Additionally, or alternatively, the memory system 210 may maintain one or more lists or tables (or both) of metadata that indicate which blocks 170 are included in each pool. For example, the memory system 210 may maintain a list indicating indexes to one or more blocks 170 that are included in the retired block pool 275, a list indicating indexes to one or more blocks 170 that are included in the spare block pool 280, a list indicating indexes to one or more blocks 170 that are included in the soft pool 285, a list indicating indexes to one or more blocks 170 that are included in the hard pool 290, or a combination thereof. The lists may be stored as a single list or separate lists and may represent examples of sets of metadata. The memory system 210 may store the sets of metadata indicative of block types in available blocks 170. For example, the memory system 210 may store the sets of metadata in blocks 170 within the spare block pool 280, or some other blocks 170 that are available for access operations, such that the memory system 210 may access the metadata. Examples of metadata for indicating types of blocks 170 are described in further detail elsewhere herein, including with reference to FIGS. 4A and 4B.

As described herein, to improve reliability and reduce overhead, the memory system 210 (e.g., using a memory system controller 215) may recover a valid block, such as a block 170 as described with reference to FIG. 1, that has been marked as “bad” using a requalification process. For example, after operating in an error protection mode for the valid block 170, the memory system 210 may monitor the valid block 170 to determine whether a status flag indicating an access error (e.g., a program status failure, an erase status failure) is set. If the status flag is set, the memory system 210 may store information that indicates the valid block 170 is unrecoverable (e.g., by sorting the block 170 to the hard pool 290), and the block 170 may subsequently be retired (e.g., by sorting the block 170 to the retired block pool 275). Alternatively, if a status flag is not set, the memory system 210 may store information that indicates the valid block 170 may be recoverable (e.g., by sorting the block 170 to the soft pool 285). While in an idle mode, the memory system 210 may perform a requalification process on the block 170, such as by performing one or more additional access operations. If the one or more additional access operations are successful, the memory system 210 may store information that indicates the block 170 may be used for subsequent access operations (e.g., by sorting the block 170 to the spare block pool 280). Such methods to requalify a block may improve memory system reliability and increase the useful life of the memory system 210, among other benefits.

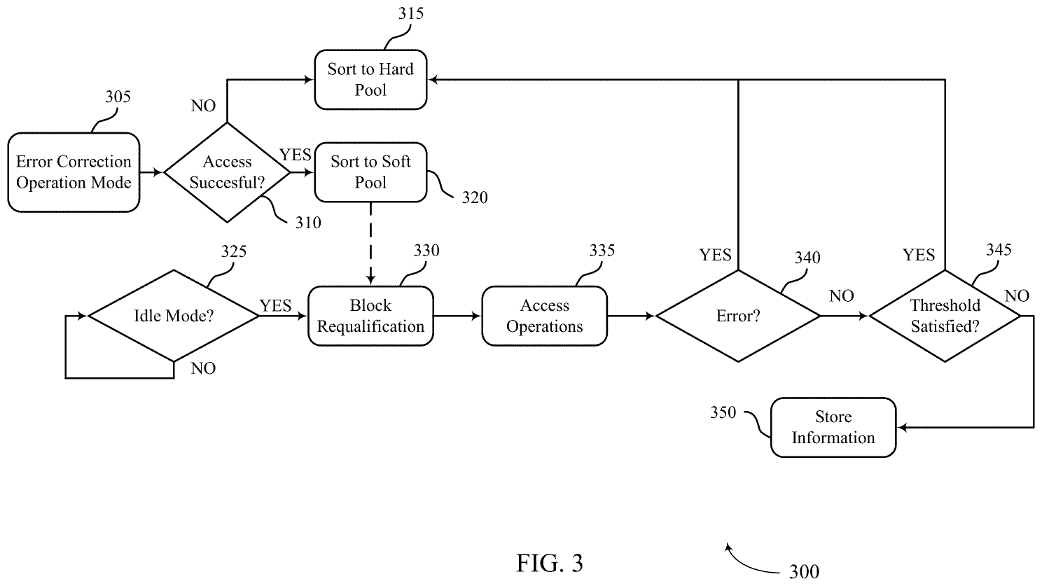

FIG. 3 shows an example of a process flow 300 that supports sorting retired blocks of non-volatile memory cells in accordance with examples as disclosed herein. In some examples, a memory system, which may be an example of the memory system 110 or the memory system 210 (or both) as described with reference to FIGS. 1 and 2, may implement aspects of the process flow 300 using a memory system controller (e.g., a memory system controller 115, a memory system controller 215). For example, the memory system controller may utilize a flash translation layer (FTL), which may perform or support aspects of the process flow 300. The FTL may include software, firmware, hardware, or a combination thereof that may manage aspects of one or more blocks of memory cells of the memory system. In the following description of process flow 300, the operations may be performed in a different order than the order shown. For example, specific operations may also be left out of process flow 300, or other operations may be added to process flow 300.

The process flow 300 may illustrate a method to support and execute a requalification operation determine whether to transfer a block from a soft pool (e.g., the soft pool 285) to a spare block pool (e.g., the spare block pool 280) or to a retired block pool (e.g., the retired block pool 275), or to transfer a block form a hard pool (e.g., the hard pool 290) to the retired block pool. In some cases, sorting the blocks into such pools may include storing metadata or other indications that may indicate the inclusion of each block in a respective pool, as described in greater detail with reference to FIGS. 4A and 4B.

At 305, the memory system may operate in an error correction mode for one or more blocks of memory cells of a memory system. For example, if the memory system detects an error in data stored to a block (e.g., as part of a read operation), the memory system may perform one or more error correction operations, such as by using one or more error correction codes (ECCs) which may detect and, in some cases, correct errors in the one or more blocks in an attempt to correct the error.

If the error correction operations are unsuccessful, a host system may trigger the error correction mode, which may be associated with increased correction and protection of the data by adjusting a ratio of data bits to parity bits and storing data in various locations within the memory system. Additionally, or alternatively, the error correction mode may be triggered due to one or more defects in the memory system. The error correction mode may include one or more higher-level error correction operations to retrieve or recover the data, such as a redundant array of independent NAND (RAIN) operation or turbo RAIN operation. Such an operation may include using error correction information corresponding to or stored across multiple blocks to recover data stored within a particular block.

At 310, the memory system may monitor an access status of the one or more blocks associated with the error correction mode (e.g., the blocks that have undergone a RAIN operation). In some cases, monitoring the status for a given block may include performing or monitoring one or more access operations for the block, such as a program operation, an erase operation, or both. The access operations may be performed as part of or in accordance with the error correction mode. In such cases, the status may include or may be an indication of whether the access operation was successful or unsuccessful, such as a program status failure (PSF), an erase status failure (ESF) or both, which, if set, may indicate that a program operation or an erase operation, respectively, were unsuccessful.

In some examples, an unsuccessful access operation (e.g., a PSF, an ESF) on a block may indicate one or more physical defects (e.g., extrinsic defects) in the block. Accordingly, if the memory system detects that the access status includes a failure indication, the memory system may determine that the access operation was unsuccessful. At 315, if the memory system determines the access operation was unsuccessful, the memory system may store information (e.g., an indication, metadata) that indicates that the block of memory cells is not available for subsequent access operations. For example, the memory system may sort (e.g., categorize) the block into the hard pool, and may subsequently retire the block (e.g., may sort the block into the retired block pool). That is, if a failure indication is set after the access operation, the memory system may determine that the block is defective and may not be able to be recovered for subsequent use.

Additionally, or alternatively, a successful access operation on a block may indicate or suggest that the cause of the error correction mode for the block was related to intrinsic operating modes, such as long-term data retention, read disturbs due to extended stress, cross temperatures, or both. In some cases, errors due to such intrinsic operating conditions may indicate that the block may be used for subsequent access operations (e.g., after accounting for the operating conditions). Accordingly, if the memory system does not detect a failure indication at 310, the memory system may determine that the access operation was successful. At 320, if the memory system determines the access operation was successful, the memory system may store information (e.g., an indication, metadata) that indicates that the block of memory cells is available for subsequent access operations. For example, the memory system may sort (e.g., categorize) the block into the soft pool, and may subsequently perform a requalification operation for the block. The hard pool and the soft pool may represent examples of the hard pool 290 and the soft pool 285, as described with reference to FIG. 2.

The memory system may trigger a requalification flow for blocks in the soft pool while the memory system is operating in an idle mode, which may correspond to a period of operation in which the memory system may receive relatively few commands from a host system, or otherwise may be relatively unoccupied with performing host commands (e.g., an idle period, an idle mode). At 325, the memory system may determine whether the memory system is operating in the idle mode. The memory system may check for the idle mode periodically, semi-statically, or based on a quantity of blocks in the soft pool, or any combination thereof. If the memory system is not operating in the idle mode, the memory system may continue to sort blocks into the hard and soft pools or may perform other operations. At 330, if the memory system transitions to operating in the idle mode, the memory system may initiate a block requalification operation for each block in the soft pool by performing one or more requalification operations on the block of memory cells.

At 335, as part of the block requalification operation for a block, the memory system may perform one or more additional access operations on the block. For example, the memory system may perform one or more erase operations on the block, may perform one or more program operations on the block, may perform one or more read operations on the block, or a combination thereof.

At 340, the memory system may monitor for errors associated with the access operations. If a quantity of errors is greater than a threshold (e.g., at least one, or some other threshold), the memory system may determine the operations are unsuccessful. The memory system may sort the block into the hard pool and may subsequently retire the block (e.g., sort the block into the retired block pool). Alternatively, if the quantity of errors is less than the threshold, the memory system may determine that the block may be requalified. The memory system may place the block in the spare block pool, and the memory system may use the block for subsequent access operations. The hard pool and the spare pool may represent examples of the hard pool 290 and the spare block pool 280 described with reference to FIG. 2.

At 345, the memory system may additionally, or alternatively, determine whether an error rate associated with the one or more additional access operations satisfies a threshold. For example, the memory system may determine a bit rate error (BER) associated with the access operations, which may indicate a quantity or fraction of bits stored in the block that contain incorrect data. In some examples, the threshold may be a fixed threshold (e.g., a same threshold applied to each block). Additionally, or alternatively, the threshold may be dependent on the block on which the error correction operation is performed. For example, the threshold may depend on an age of the block, a quantity of access operations (e.g., a quantity of read operations, a quantity of program operations, a quantity of erase operations) that have been performed on the block, or both.

In some examples, the BER may be an example of a raw BER (RBER), that may correspond to quantity or fraction of bits stored in the block that contain incorrect data prior to correcting one or more errors using an error correction operation. Additionally, or alternatively, the BER may be an example of an uncorrectable BER (UBER), that may correspond to a quantity or fraction of bits stored in the block that contain incorrect data after correcting one or more errors using the error correction operation. If the error rate satisfies the threshold (e.g., exceeds the threshold), the memory system may sort the block to the hard pool at 315, which may signal that the block is to be retired.

At 350, the memory system may store information that indicates that the block is available for one or more subsequent access operations. For example, if the access operations are successful at 340 or if the error rate is less than the threshold at 345, or both, the memory system may determine that the block may be requalified. The memory system may place the block in the spare block pool, and the memory system may use the block for subsequent access operations. Requalifying the blocks sorted into the soft pool may improve memory system reliability and increase the useful life of the memory system, reduce manufacturing costs (e.g., by allowing for increased yield), and allow for more robust manufacturing processes (e.g., improved soldering processes), among other benefits.

FIGS. 4A and 4B show examples of a set of metadata 400-a and a set of metadata 400-b, respectively, that support sorting retired blocks of non-volatile memory cells in accordance with examples as disclosed herein. The sets of metadata 400-a and 400-b may be conceptual examples of storing metadata associated with each of one or more blocks of a memory system (e.g., blocks 170 of a memory system 110, a memory system 210, or both, as described with reference to FIGS. 1-3).

In some examples, the sets of metadata 400-a and 400-b may be stored across various portions of the memory system, such as in one or more blocks dedicated to storing metadata, alongside user data within a block, or a combination thereof. In some examples, the metadata may be stored across blocks that are available for subsequent access operations (e.g., blocks in the spare pool). To sort a block to a particular category (e.g., the retired block pool 275, the spare block pool 280, the soft pool 285, or the hard pool 290), the memory system may store metadata that includes information associated with the respective category, along with a block identifier. In some cases, a block identifier may be an example of a number or a string of bits that identifies the associated block. For example, a block identifier may be an address corresponding to the associated block (e.g., a physical address, a logical address), or otherwise include a bit sequence unique to the associated block. The metadata may be stored in one or more different formats, as illustrated in FIGS. 4A and 4B.

FIG. 4A illustrates a first example of a set of metadata 400-a that may include one or more different lists or sets of metadata. For example, the set of metadata 400-a may be stored as or may include one or more lists associated with different categories, such as a retired (e.g., bad block) list 405 associated with the retired block pool 275, a spare list 415 associated with the spare block pool 280, a soft list 425 associated with the soft pool 285, and a hard list 435 associated with the hard pool 290. In some examples, a list may include one or more block identifiers corresponding to blocks that have been sorted in the list.

The retired list 405 may include block identifiers 410-a through 410-m, which may correspond to blocks that have been retired (e.g., unavailable for access operations), the spare list 415 may include block identifiers 420-a through 420-m, which may correspond to blocks that are available for access operations, the soft list 425 may include block identifiers 430-a through 430-m, which may correspond to blocks that may be eligible for a requalification operation (e.g., as described with reference to FIG. 3), and the hard list 435 may include block identifiers 440-a through 440-m, which may correspond to blocks that are to be retired (e.g., subsequently sorted into the retired list 405). Although four separate lists are illustrated in FIG. 4, it is to be understood that the memory system may store any quantity of lists indicating any type of blocks, including the four types illustrated in FIG. 4 or any other combination of block types.

In some cases, to sort a block into a list, a block identifier of the block may be added to the list. By way of non-limiting example, the memory system may sort a block that has undergone an error correction mode (e.g., a RAIN operation) and has successfully performed a subsequent access operation (e.g., a block without an ongoing PSF, ESF, or both) to the soft list 425 by storing the block identifier to the soft list 425. In some cases, the memory system may store additional metadata, such as an indication that the subsequent access operation was successful. Subsequently, as part of a requalification process (e.g., as described with reference to FIG. 3) the memory system may perform one or more additional access operations on the block. If the additional access operations are successful, the memory system may sort the block to the spare list 415 by removing the block identifier from the soft list 425 and storing the block identifier to the spare list 415.

FIG. 4B illustrates a second example of a set of metadata 400-b, which may be stored as a metadata table 445. The metadata table 445 may store a mapping between a block and a category corresponding to the block. For example, the metadata table 445 may store one or more indications associated with different categories, such as a retired block indication 455 associated with the retired block pool 275, a spare block indication 460 associated with the spare block pool 280, a soft indication 465 associated with the soft pool 285, and a hard indication 470 associated with the hard pool 290. The one or more indications may represent examples of metadata or other information that indicates or points to a respective type of block. The metadata table 445 may be indexed by unique block identifiers 450, such as block addresses or other unique identifiers.

By way of example, the metadata table 445 may include one or more entries mapping a block identifier 450 to a category, such as a first entry that maps a block identifier 450-a to the retired block pool 275 using the retired block indication 455, a second entry that maps a block identifier 450-b to the spare block pool 280 using the spare block indication 460, a third entry that maps a block identifier 450-c to the soft pool 285 using the soft indication 465, and a fourth entry that maps a block identifier 450-d to the hard pool 290 using the hard indication 470. In some cases, to sort a block to a category, the memory system may add an entry that includes a block identifier 450 of the block and an indication corresponding to the category to the metadata table 445. Additionally, or alternatively, the memory system may update an existing entry that includes a block identifier 450 to change an existing indication to a current indication corresponding to a current category associated with the block.

The memory system may thereby sort the blocks into various categories based on one or more conditions associated with the block by storing metadata or other information that indicates the category of each block. The memory system may utilize the categorical information to improve block retention and reliability of the memory system.

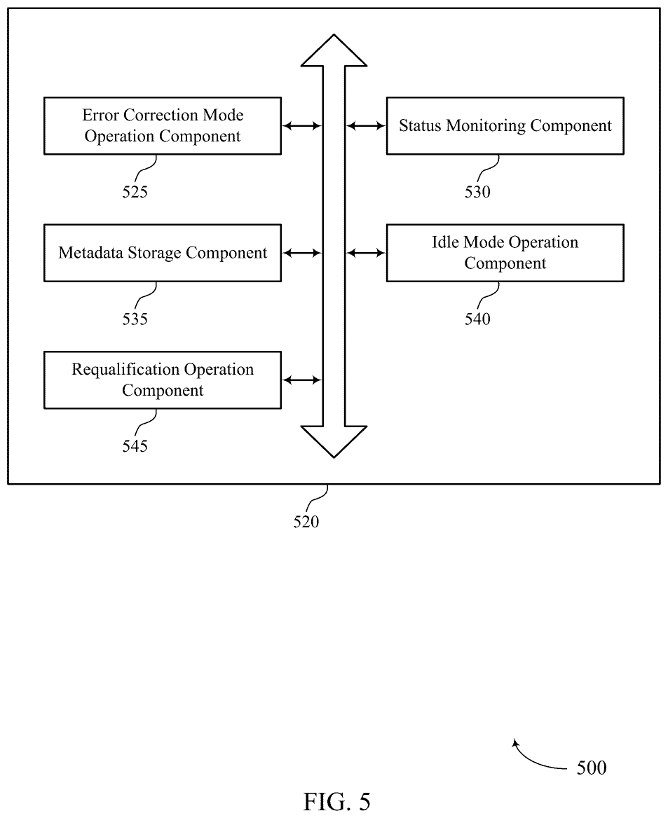

FIG. 5 shows a block diagram 500 of a memory system 520 that supports sorting retired blocks of non-volatile memory cells in accordance with examples as disclosed herein. The memory system 520 may be an example of aspects of a memory system as described with reference to FIGS. 1 through 4. The memory system 520, or various components thereof, may be an example of means for performing various aspects of sorting retired blocks of non-volatile memory cells as described herein. For example, the memory system 520 may include an error correction mode operation component 525, a status monitoring component 530, a metadata storage component 535, an idle mode operation component 540, a requalification operation component 545, or any combination thereof. Each of these components, or components of subcomponents thereof (e.g., one or more processors, one or more memories), may communicate, directly or indirectly, with one another (e.g., via one or more buses).

The error correction mode operation component 525 may be configured as or otherwise support a means for operating in an error correction mode for one or more blocks of memory cells of a memory system. The status monitoring component 530 may be configured as or otherwise support a means for monitoring, for a block of memory cells of the one or more blocks of memory cells and based on the error correction mode, a status associated with the block of memory cells, where the status indicates whether an access operation for the block of memory cells is successful. The metadata storage component 535 may be configured as or otherwise support a means for storing information that indicates whether the block of memory cells is available for one or more subsequent access operations, the information based on the status associated with the block of memory cells.

In some examples, the information includes an indication that the block of memory cells is not available based on the status indicating that the access operation is unsuccessful.

In some examples, the information includes an indication that the block of memory cells is available based on the status indicating that the access operation is successful.

In some examples, the idle mode operation component 540 may be configured as or otherwise support a means for operating the memory system in an idle mode. In some examples, the requalification operation component 545 may be configured as or otherwise support a means for performing, while operating in the idle mode, one or more requalification operations on the block of memory cells based on the block of memory cells being included in a first group of blocks, where the block of memory cells is included in the first group of blocks based on the status indicating that the access operation for the block of memory cells is successful, and where storing the information is further based on the one or more requalification operations.

In some examples, the information indicates that the block of memory cells is available for the one or more subsequent access operations based on an error rate associated with the one or more requalification operations being less than or equal to a threshold error rate.

In some examples, the information indicates that the block of memory cells is not available for the one or more subsequent access operations based on the one or more requalification operations being unsuccessful.

In some examples, the information indicates that the block of memory cells is not available for the one or more subsequent access operations based on an error rate associated with the one or more requalification operations being greater than a threshold error rate.

In some examples, the metadata storage component 535 may be configured as or otherwise support a means for storing first information that indicates that the block of memory cells is recoverable from an error condition based on the status indicating that the access operation is successful, where the first information further indicates that the block is included in the first group of blocks.

In some examples, the one or more requalification operations include one or more erase operations, one or more program operations, one or more read operations, or any combination thereof to refresh the block of memory cells for the one or more subsequent access operations.

In some examples, to support storing the information, the metadata storage component 535 may be configured as or otherwise support a means for storing, in a set of metadata, first metadata including the information and a first identifier of the block of memory cells, and second metadata including second identifiers of one or more second blocks of memory cells from among the one or more blocks of memory cells of the memory system and second information that indicates whether the one or more second blocks of memory cells are available for subsequent access operations.

In some examples, the first identifier includes an address associated with the block of memory cells.

In some examples, the error correction mode is based on a failed read operation for the one or more blocks of memory cells.

In some examples, the error correction mode includes a RAIN operation.

In some examples, the access operation includes a program operation or an erase operation. In some examples, the status includes an erase status failure indication or a program status failure indication.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

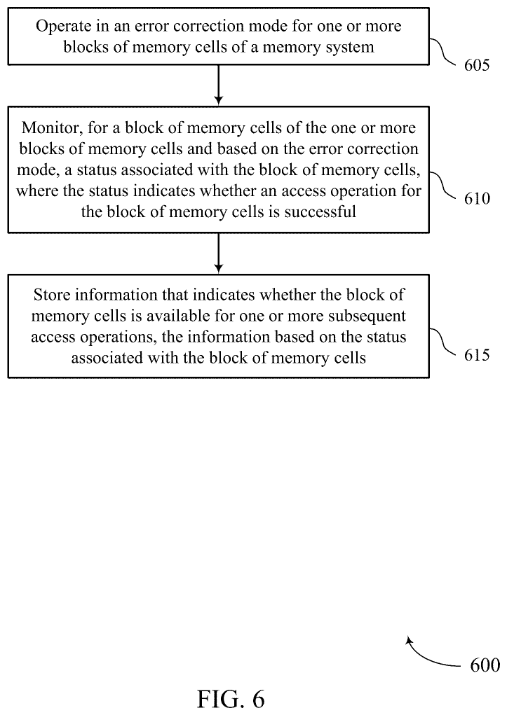

FIG. 6 shows a flowchart illustrating a method 600 that supports sorting retired blocks of non-volatile memory cells in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include operating in an error correction mode for one or more blocks of memory cells of a memory system. In some examples, aspects of the operations of 605 may be performed by an error correction mode operation component 525 as described with reference to FIG. 5. For example, the memory system may include a controller (e.g., a memory system controller 115, a memory system controller 215) that implements aspects of the error correction mode operation component 525 to perform (e.g., at step 305 of process flow 300) one or more error correction operations, such as a RAIN operation, on the one or more blocks.

At 610, the method may include monitoring, for a block of memory cells of the one or more blocks of memory cells and based on the error correction mode, a status associated with the block of memory cells, where the status indicates whether an access operation for the block of memory cells is successful. In some examples, aspects of the operations of 610 may be performed by a status monitoring component 530 as described with reference to FIG. 5. For example, the memory system may include a controller (e.g., a memory system controller 115, a memory system controller 215) that implements aspects of the status monitoring component 530 to determine (e.g., at step 310 of process flow 300) whether the access operation was successful.

At 615, the method may include storing information that indicates whether the block of memory cells is available for one or more subsequent access operations, the information based on the status associated with the block of memory cells. In some examples, aspects of the operations of 615 may be performed by a metadata storage component 535 as described with reference to FIG. 5. For example, the memory system may include a controller (e.g., a memory system controller 115, a memory system controller 215) that implements aspects of the metadata storage component to store (e.g., at step 350 of process flow 300, at step 315 of the process flow 300) metadata indicating the information.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for operating in an error correction mode for one or more blocks of memory cells of a memory system; monitoring, for a block of memory cells of the one or more blocks of memory cells and based on the error correction mode, a status associated with the block of memory cells, where the status indicates whether an access operation for the block of memory cells is successful; and storing information that indicates whether the block of memory cells is available for one or more subsequent access operations, the information based on the status associated with the block of memory cells.

Aspect 2: The method, apparatus, or non-transitory computer-readable medium of aspect 1, where the information includes an indication that the block of memory cells is not available based on the status indicating that the access operation is unsuccessful.

Aspect 3: The method, apparatus, or non-transitory computer-readable medium of any of aspects 1 through 2, where the information includes an indication that the block of memory cells is available based on the status indicating that the access operation is successful.

Aspect 4: The method, apparatus, or non-transitory computer-readable medium of any of aspects 1 through 3, further including operations, features, circuitry, logic, means, or instructions, or any combination thereof for operating the memory system in an idle mode and performing, while operating in the idle mode, one or more requalification operations on the block of memory cells based on the block of memory cells being included in a first group of blocks, where the block of memory cells is included in the first group of blocks based on the status indicating that the access operation for the block of memory cells is successful, and where storing the information is further based on the one or more requalification operations.

Aspect 5: The method, apparatus, or non-transitory computer-readable medium of aspect 4, where the information indicates that the block of memory cells is available for the one or more subsequent access operations based on an error rate associated with the one or more requalification operations being less than or equal to a threshold error rate.

Aspect 6: The method, apparatus, or non-transitory computer-readable medium of any of aspects 4 through 5, where the information indicates that the block of memory cells is not available for the one or more subsequent access operations based on the one or more requalification operations being unsuccessful.

Aspect 7: The method, apparatus, or non-transitory computer-readable medium of any of aspects 4 through 6, where the information indicates that the block of memory cells is not available for the one or more subsequent access operations based on an error rate associated with the one or more requalification operations being greater than a threshold error rate.

Aspect 8: The method, apparatus, or non-transitory computer-readable medium of any of aspects 4 through 7, further including operations, features, circuitry, logic, means, or instructions, or any combination thereof for storing first information that indicates that the block of memory cells is recoverable from an error condition based on the status indicating that the access operation is successful, where the first information further indicates that the block is included in the first group of blocks.

Aspect 9: The method, apparatus, or non-transitory computer-readable medium of any of aspects 4 through 8, where the one or more requalification operations include one or more erase operations, one or more program operations, one or more read operations, or any combination thereof to refresh the block of memory cells for the one or more subsequent access operations.

Aspect 10: The method, apparatus, or non-transitory computer-readable medium of any of aspects 1 through 9, where storing the information includes operations, features, circuitry, logic, means, or instructions, or any combination thereof for storing, in a set of metadata, first metadata including the information and a first identifier of the block of memory cells, and second metadata including second identifiers of one or more second blocks of memory cells from among the one or more blocks of memory cells of the memory system and second information that indicates whether the one or more second blocks of memory cells are available for subsequent access operations.

Aspect 11: The method, apparatus, or non-transitory computer-readable medium of aspect 10, where the first identifier includes an address associated with the block of memory cells.

Aspect 12: The method, apparatus, or non-transitory computer-readable medium of any of aspects 1 through 11, where the error correction mode is based on a failed read operation for the one or more blocks of memory cells.

Aspect 13: The method, apparatus, or non-transitory computer-readable medium of any of aspects 1 through 12, where the error correction mode includes a RAIN operation.

Aspect 14: The method, apparatus, or non-transitory computer-readable medium of any of aspects 1 through 13, where the access operation includes a program operation or an erase operation and the status includes an erase status failure indication or a program status failure indication.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processor. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
operating in an error correction mode for one or more blocks of memory cells of a memory system;
monitoring, for a block of memory cells of the one or more blocks of memory cells and based on the error correction mode, a status associated with the block of memory cells, wherein the status indicates whether an access operation for the block of memory cells is successful; and
storing information that indicates whether the block of memory cells is available for one or more subsequent access operations, the information based on the status associated with the block of memory cells.

2. The method of claim 1, wherein the information comprises an indication that the block of memory cells is not available based on the status indicating that the access operation is unsuccessful.

3. The method of claim 1, wherein the information comprises an indication that the block of memory cells is available based on the status indicating that the access operation is successful.

4. The method of claim 1, further comprising:
operating the memory system in an idle mode; and
performing, while operating in the idle mode, one or more requalification operations on the block of memory cells based on the block of memory cells being included in a first group of blocks, wherein the block of memory cells is included in the first group of blocks based on the status indicating that the access operation for the block of memory cells is successful, and wherein storing the information is further based on the one or more requalification operations.

5. The method of claim 4, wherein the information indicates that the block of memory cells is available for the one or more subsequent access operations based on an error rate associated with the one or more requalification operations being less than or equal to a threshold error rate.

6. The method of claim 4, wherein the information indicates that the block of memory cells is not available for the one or more subsequent access operations based on the one or more requalification operations being unsuccessful.

7. The method of claim 4, wherein the information indicates that the block of memory cells is not available for the one or more subsequent access operations based on an error rate associated with the one or more requalification operations being greater than a threshold error rate.

8. The method of claim 4, further comprising:
storing first information that indicates that the block of memory cells is recoverable from an error condition based on the status indicating that the access operation is successful, wherein the first information further indicates that the block is included in the first group of blocks.

9. The method of claim 4, wherein the one or more requalification operations comprise one or more erase operations, one or more program operations, one or more read operations, or any combination thereof to refresh the block of memory cells for the one or more subsequent access operations.

10. The method of claim 1, wherein storing the information comprises:
storing, in a set of metadata, first metadata comprising the information and a first identifier of the block of memory cells, and second metadata comprising second identifiers of one or more second blocks of memory cells from among the one or more blocks of memory cells of the memory system and second information that indicates whether the one or more second blocks of memory cells are available for subsequent access operations.

11. The method of claim 10, wherein the first identifier comprises an address associated with the block of memory cells.

12. The method of claim 1, wherein the error correction mode is based on a failed read operation for the one or more blocks of memory cells.

13. The method of claim 1, wherein the error correction mode comprises a redundant array of independent not-and (RAIN) operation.

14. The method of claim 1, wherein the access operation comprises a program operation or an erase operation, and the status comprises an erase status failure indication or a program status failure indication.

15. A non-transitory computer-readable medium storing code, the code comprising instructions executable by one or more processors to:
operate in an error correction mode for one or more blocks of memory cells of a memory system;
monitor, for a block of memory cells of the one or more blocks of memory cells and based on the error correction mode, a status associated with the block of memory cells, wherein the status indicates whether an access operation for the block of memory cells is successful; and
store information that indicates whether the block of memory cells is available for one or more subsequent access operations, the information based on the status associated with the block of memory cells.

16. The non-transitory computer-readable medium of claim 15, wherein the information comprises an indication that the block of memory cells is not available based on the status indicating that the access operation is unsuccessful.

17. The non-transitory computer-readable medium of claim 15, wherein the information comprises an indication that the block of memory cells is available based on the status indicating that the access operation is successful.

18. The non-transitory computer-readable medium of claim 15, wherein the instructions are further executable by the one or more processors to:
operate the memory system in an idle mode; and
perform, while operating in the idle mode, one or more requalification operations on the block of memory cells based on the block of memory cells being included in a first group of blocks, wherein the block of memory cells is included in the first group of blocks based on the status indicating that the access operation for the block of memory cells is successful, and wherein storing the information is further based on the one or more requalification operations.

19. The non-transitory computer-readable medium of claim 18, wherein the information indicates that the block of memory cells is available for the one or more subsequent access operations based on an error rate associated with the one or more requalification operations being less than or equal to a threshold error rate.

20. An apparatus, comprising: a controller associated with a memory device, wherein the controller is configured to cause the apparatus to:
operate in an error correction mode for one or more blocks of memory cells of a memory system;
monitor, for a block of memory cells of the one or more blocks of memory cells and based on the error correction mode, a status associated with the block of memory cells, wherein the status indicates whether an access operation for the block of memory cells is successful; and
store information that indicates whether the block of memory cells is available for one or more subsequent access operations, the information based on the status associated with the block of memory cells.
